(19) United States
(12) Patent Application Publication
(10) Pub. No.: US 2008/0127844 A1
(43) Pub. Date: Jun. 5, 2008

(54) PAD PRINTING SYSTEM WITH INDEPENDENT AND VARIABLE COMPRESSION DEVICE

(76) Inventors: Anatoly Gosis, Palatine, IL (US); Tracy Rucaba, South Elgin, IL (US); Frank Otte, Mount Prospect, IL (US); Christopher Schaafsma, Wheaton, IL (US)

Correspondence Address: CARDINAL LAW GROUP, Suite 2000, 1603 Orrington Avenue, Evanston, IL, 60201, US

(21) Appl. No.: 11/927,404

(22) Filed: Oct. 29, 2007

Related U.S. Application Data
(60) Provisional application No. 60/867,997, filed on Nov. 30, 2006.

(51) Int. Cl. B41F 9/10

(52) U.S. Cl. 101/169

(57) ABSTRACT

A pad printing system includes a doctor assembly, a first force applicator, and a second force applicator. The doctor assembly further includes a first set of opposing contact points and a second set of opposing contact points, wherein the first set is offset from the second set. The first force applicator is operable to apply force at the first set of contact points and the second force applicator is operable to apply a force to the second set of contact points.

### RELATED APPLICATIONS

This application claims the benefit of, and priority to, U.S. Provisional Patent Application 60/867,997 filed Nov. 30, 2006, the entirety of which is hereby incorporated by reference.

### TECHNICAL FIELD OF THE INVENTION

The present invention relates generally to printing and in particular to pad printing.

### BACKGROUND OF THE INVENTION

Pad printing has been used for many years to apply an image to a product. Pad printing is especially prevalent in applications for applying images to rounded products, such as syringes and golf balls.

Efficient ink transfer is important to final image quality in a pad printing system. A doctor assembly includes an ink cup having a rigidly attached annular wiping element known as a doctor. An image bearing cliche device cycles its position to place the image under a resilient printing pad, the doctor then scrapes the excess ink guided by the un-patterned surface of the cliché device. The cliché device surface is not flat, but is within tolerances for the pad printing system. The same is true for the doctor annular surface. As a result of these irregularities in the surfaces, the two surfaces do not create a 100% contact match, thus allowing some ink to escape through the areas of mismatch. Prolonged lapping of the respective surfaces causes both surfaces to wear thereby reducing the initial surface mismatch when the surfaces are static.

A compression device is used to maintain contact between the doctor assembly and the cliché device. The compression device maintains this contact by the application of force on the doctor assembly. The contact must be sufficient to prevent ink from escaping between the doctor assembly and the cliché device. Excessive contact pressure results in premature wear of the cliché device and the doctor. The compression device provides contact pressure while the cliché device or the doctor assembly is stationary or while either component is in motion.

FIG. 1a illustrates a top view of one example of a pad printing system in accordance with the prior art at 100.

The pad printing system 105 includes a cliché device 110 and a doctor assembly 112. The doctor assembly includes an ink cup 120 having a rim 122. Doctor assembly 112 is located in contact with cliche device 110. Two axially opposed contact points 140a and 140b are shown on rim 122, located in the equatorial plane of ink cup 120. Contact pressure between doctor assembly 112 and cliché device 110 is provided by a force applicator 142 that includes a pair of force transfer units 142a and 142b contacting rim 122 at axially opposed contact points 140a and 140b. In one example, doctor assembly 112 is fixed to support 144 and cliché device 110 is translated laterally in contact with doctor assembly. In another embodiment, cliché device 110 is fixed and doctor assembly 112 is translated across cliché device 110.

FIG. 1b illustrates a side view of one example of a pad printing system, in accordance with the prior art at 101.

An annular doctor blade 130 is affixed to rim 122 of doctor assembly 112. Annular doctor blade 130 provides a seal between doctor assembly 112 and cliché device 110 that limits the quantity of ink that can leak from ink cup 120. In addition, the annular doctor blade wipes excess ink from cliché device 110 as the doctor assembly and the cliche device move relative to each other. Force applicator 142a engages rim 122 at contact point 140a.

FIG. 2 illustrates one example of a pad printing system in operation, in accordance with the prior art at 200. When the pad printing system 105 begins a print cycle, cliché device 110 starts a lateral translation with respect to the doctor assembly 112. As the cliché device moves, in contact with the doctor blade, static friction is converted to dynamic friction, inducing the ink cup to pivot around a line through contact point 142a and perpendicular to the direction of motion. The dynamic friction pivots a leading edge 150 of ink cup 120 down against cliché device 110 and consequently allows a trailing edge 152 to pivot away from cliché device 110. The portion of the doctor assembly that first traverses an image portion 260 of the cliché device is termed the leading edge. This pivoting motion results in a periodic separation of cliché device 110 and doctor blade 130 adjacent the trailing edge of doctor assembly 112.

The periodic separation of doctor assembly 112 and cliché device 110 allows ink to leak from ink-cup 120 as the cliché device moves relative to the doctor assembly. The quantity of ink that leaks is dependent on various process parameters such as acceleration, deceleration, and velocity of the cliché device or the doctor assembly. The ink that has leaked needs to be periodically cleaned from the system. Additionally, the separation of the cliché and the doctor assembly allows possible contamination of the ink by foreign material. Furthermore, the increase in contact force at leading edge 150, by doctor blade 130, contributes to premature wear of cliché device 110.

It is, therefore, desirable to provide a system for pad printing that would overcome the aforementioned and other disadvantages.

### SUMMARY OF THE INVENTION

One aspect of the invention provides a pad printing system, including a doctor assembly, the doctor assembly including a first set of opposing contact points and a second set of opposing contact points, wherein the first set is offset from the second set, and a first force applicator applying force at the first set and a second force applicator applying force at the second set.

Another aspect of the invention provides a method for pad printing including applying a first force at a first set of contact points, applying a second force at a second set of contact points, wherein the first set is offset from the second set, and translating one of the doctor assembly or the cliché device relative to each other.

A third aspect of the invention provides a system for pad printing including means for applying a first force at a first set of contact points, means for applying a second force at a second set of contact points, wherein the first set is offset from the second set, and means for translating one of the doctor assembly or the cliché device relative to each other.

The aforementioned and other features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1a illustrates a top view of one example of a pad printing system in accordance with the prior art;

FIG. 1b illustrates a side view of one example of a pad printing system, in accordance with the prior art;

FIG. 2 illustrates one example of a pad printing system in operation, in accordance with the prior art;

FIG. 3 illustrates a schematic representative of a top view of one example of a pad printing system with uniform compression device, in accordance with the invention;

FIG. 4 illustrates a schematic representative of a side view of one example of a pad printing system with uniform compression device, in accordance with the invention;

FIG. 5a through FIG. 5b illustrates schematics representative of one example of a pad printing system with uniform compression device in operation, in accordance with the invention;

FIG. 6 illustrates a flowchart of one example of a method for pad printing with uniform compression device, in accordance with the invention; and

FIG. 7a through FIG. 7b illustrates schematics representative of one example of a force applicator, in accordance with the invention.

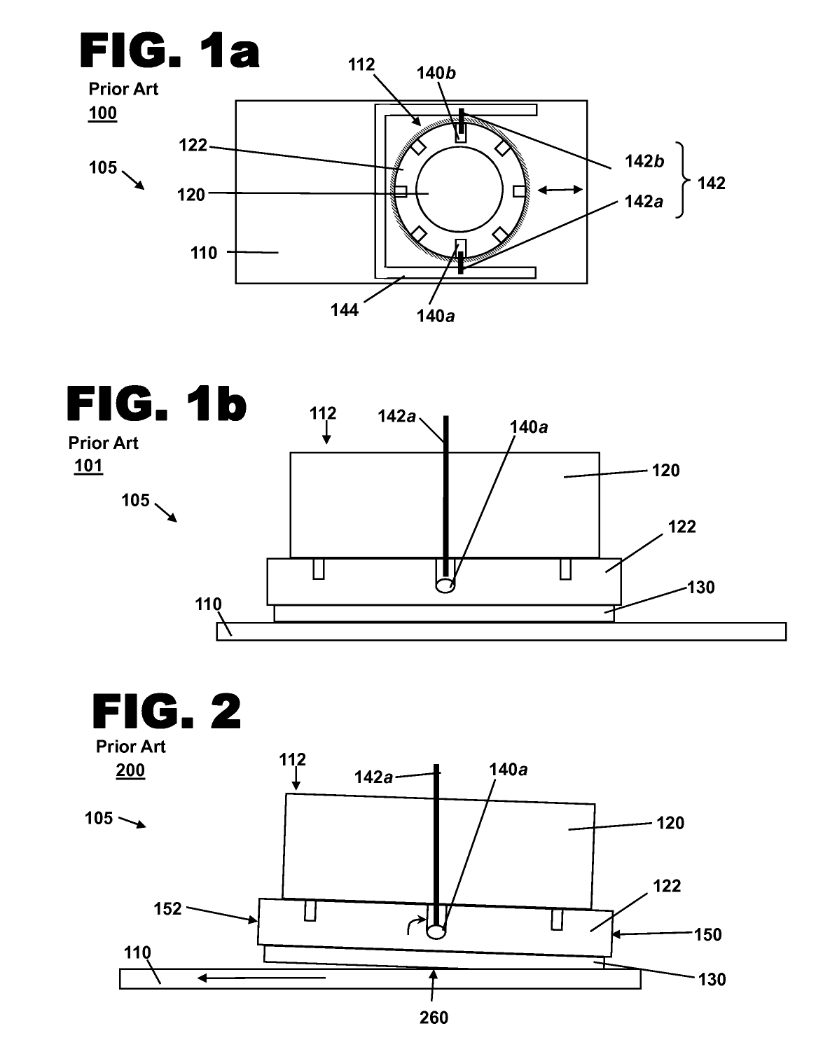

### DETAILED DESCRIPTION OF THE PRESENTLY PREFERRED EMBODIMENTS

The invention provides for the independent application of forces along an ink cup to counter a pivot force applied by virtue of friction forces. In addition, the independent application of force reduces wear and tear on cliche devices. Further, the ink cup can float over inconsistent surfaces of either the cliché device or doctor. In addition, active adjustment of the hold down force applied to a front of the ink cup and a back of the ink cup allows for improved countering of the friction pivot and improved doctoring of the cliché device with reduced hold down forces.

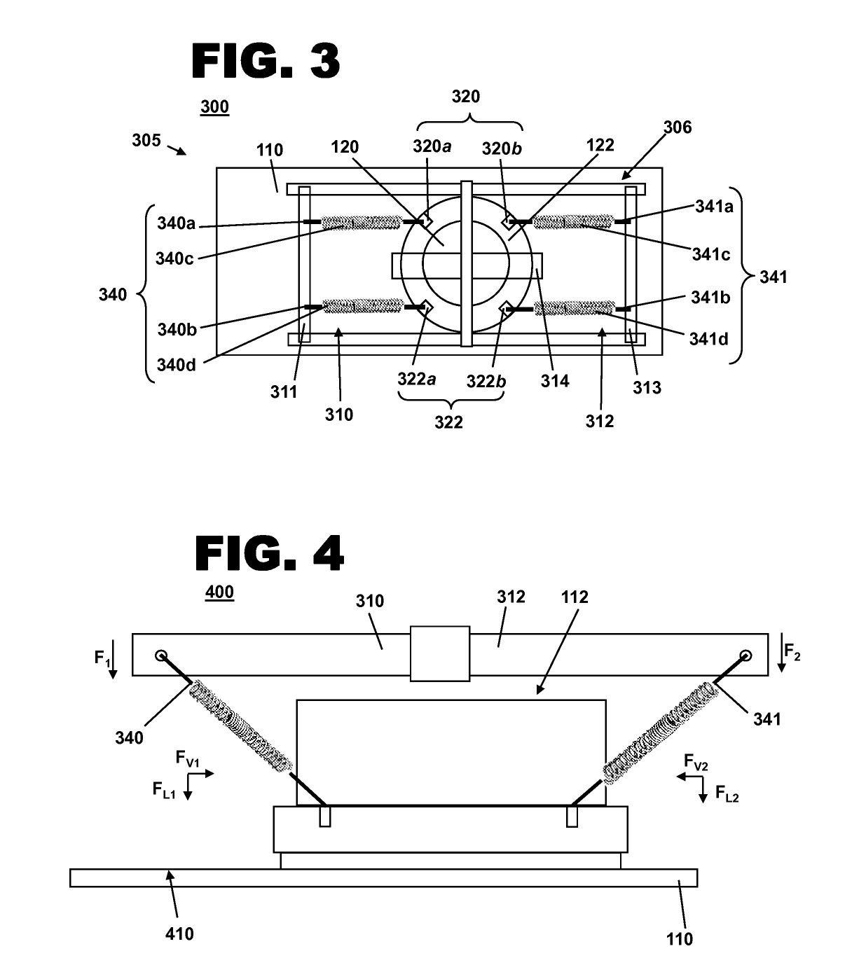

FIG. 3 illustrates a schematic representative of a top view of one example of a pad printing system with uniform compression device, in accordance with the invention at 300.

The pad printing system 305 includes doctor assembly 112, a uniform compression device 306, and a cliché device 110. The doctor assembly includes ink-cup 120 having rim 122. The doctor assembly also includes a first set 320 of contact points 320a, 320b and a second set 322 of contact points 322a, 322b at which a hold down force F₁ is applied to the doctor assembly by the uniform compression device. The hold down force assists in maintaining contact between the doctor assembly 112 and the cliché device 110 during operation of the pad printing system.

Each set of contact points 320 and 322 includes at least two contact points located at approximately opposite coplanar positions on rim 122 of ink cup 120. In one embodiment, the contact points are positioned as far apart as possible to increase uniform contact between doctor assembly 112 and cliché 110. In one example, doctor assembly 112 includes more than two sets of contact points. In another example, the doctor assembly includes one set of contact points, the set having at least three contact points. In a further example, the contact points are non-coplanar.

Uniform compression device 306 includes a first force applicator 310, and a second force applicator 312. A cup stop 314 is located adjacent doctor assembly 112. Cup stop 314 limits lateral motion of the doctor assembly.

Hold down force F₁ is supplied at each set of contact points through force applicators 310, 312. In one example, force applicators 310, 312 are connected in a single force applicator unit. Each force applicator 310, 312 includes a set of force transfer units 340, 341. The hold down force F₁ is transferred from force applicators 310, 312 to doctor assembly 112 through sets of force transfer units 340, 341. Each set includes two force transfer units 340a, 340b and 341a, 341b. The force transfer units each include a spring device 340c, 340d and 341c, 341d for applying a variable degree of force at each contact point in contact point sets 320, 322 on rim 122 of doctor assembly 112. In one example, the force transfer units are included as an attachment to a push rod (not shown).

Each force transfer unit in sets 340, 341 is pivotally attached at one end to doctor assembly 112 and at a second end, linearly displaced from the first, to a cross-bar 311, 313. In one example, the force transfer units in sets 340, 341 are fixedly attached at one end to doctor assembly 112 and at a second end, linearly displaced from the first end, to cross-bar 311, 313. In another example, a combination of fixed and pivoting attachments is used.

FIG. 4 illustrates a schematic representative of a side view of one example of a pad printing system with uniform compression device, in accordance with the invention at 400.

Both sets of force transfer units 340 and 341 extend, respectively, from cross-bar 311, 313 to doctor assembly 112 at a non-zero angle relative to a center axis of the doctor assembly. Force applicators 310, 312 apply forces F₁ and F₂, respectively, in a direction parallel to the center axis of the doctor assembly. The angled orientation of the force transfer units translates the hold down forces F₁ and F₂ into vertical force components F_{V1} and F_{V2} and lateral force components F_{L1} and F_{L2}.

When there is no movement of the system the vertical force components are static and approximately equal at each force transfer unit. The vertical force components maintain contact between cliché device 110 and doctor assembly 112 adjacent an image portion 260 of the cliché device.

The lateral force components, which would tend to displace doctor assembly 112, are also static. Lateral force component F_{L1} is balanced by an equal and opposite lateral force component F_{L2}. In one embodiment, wherein three force transfer units are used, one force transfer unit is designed to provide vertical and lateral and forces to balance those forces supplied by two other opposing force transfer units. Each force transfer unit engages the respective contact point at a point or small arc in an attempt to minimize the magnitude of lateral forces on the doctor assembly.

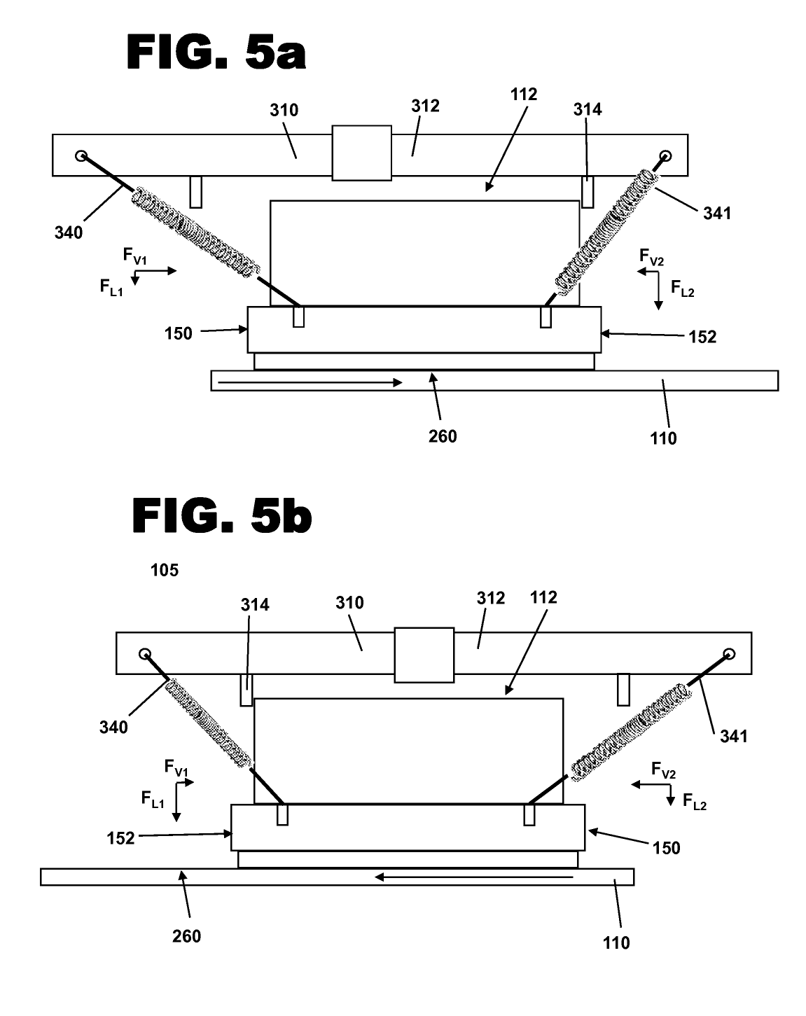

FIG. 5a through FIG. 5b illustrates schematics representative of one example of a pad printing system with uniform compression device in operation, in accordance with the invention at 500.

As cliché device 110 is translated relative to doctor assembly 112, as illustrated in FIG. 5a, dynamic frictional forces are generated that are greatest at the leading edge 150 of doctor assembly 112. The dynamic frictional forces generated by translation of the cliché device tend to bias pivot leading edge 150 down against the cliché device. To compensate for the effect of this dynamic frictional force, the doctor assembly slides against cup stop 314 adjacent trailing edge 152 of doctor assembly 112. As doctor assembly 112 slides against cup stop 314, the spring devices in the set of force transfer units 340 adjacent leading edge 150 extend, thereby reducing the hold down force at the leading edge. The extension of the spring devices functions to lift the leading edge away from cliche device 110, thereby compensating for the increased frictional force and the tendency for the leading edge to pivot down against the cliché device.

Additionally, each spring device in the set of force transfer units 341 adjacent trailing edge 152 of doctor assembly 112 compresses as the doctor assembly slides against cup stop 314, thereby increasing the hold down force at the trailing edge. The compression of the spring devices functions to push the trailing edge down against cliché device 110, thereby compensating for the tendency for the trailing edge to pivot away from the cliché device.

As cliché device 110 is translated relative to doctor assembly 112, in the opposite direction, as illustrated in FIG. 5b, the trailing edge and the leading edge are reversed. The operation of the uniform compression device is a function of the direction of travel. The action of the spring device of the force transfer units is therefore analogous to that in the previous example.

In one example, the doctor assembly is translated relative to the cliché device. The operation of uniform compression device 306 corresponds to the example where the cliché device is translated relative to the doctor assembly. The leading edge of the doctor assembly, in either example, is the portion of the doctor assembly that first traverses image portion 260 of the cliché device.

Replacing one or more of the spring devices in force applicator 310, 312 with a spring device having a different spring tension allows the system to be tuned in an attempt to provide the most effective force balance. In one example the spring device has an adjustable spring tension.

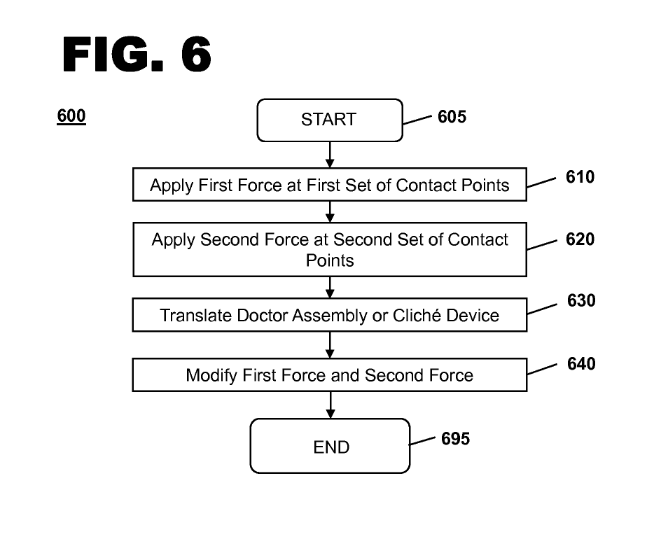

FIG. 6 illustrates a flowchart of one example of a method for pad printing with uniform compression device, in accordance with the invention at 600. The method begins (block 605).

A first force is supplied to a first set of contact points (block 610) and a second force is supplied to a second set of contact points (block 620). The first set of contact points is offset from the second set of contact points. The first force and the second force are supplied by a uniform compression device. The contact points are located on the doctor assembly of the pad printing system. The first and second forces keep the doctor assembly in contact with an image bearing cliché device.

The doctor assembly or the cliché device is translated one relative to the other (block 630). The translation includes moving the image portion of the cliché device back and forth beneath the doctor assembly where ink is deposited on the image portion of the cliché device and then excess ink is removed.

The first force and the second forces are modified (block 640) independently to maintain uniform contact between the doctor assembly and the cliché device as the doctor assembly and the cliché device are translated relative to each other. The uniform contact helps prevent ink from leaking from between the doctor assembly and the cliché device.

The method terminates at block 695.

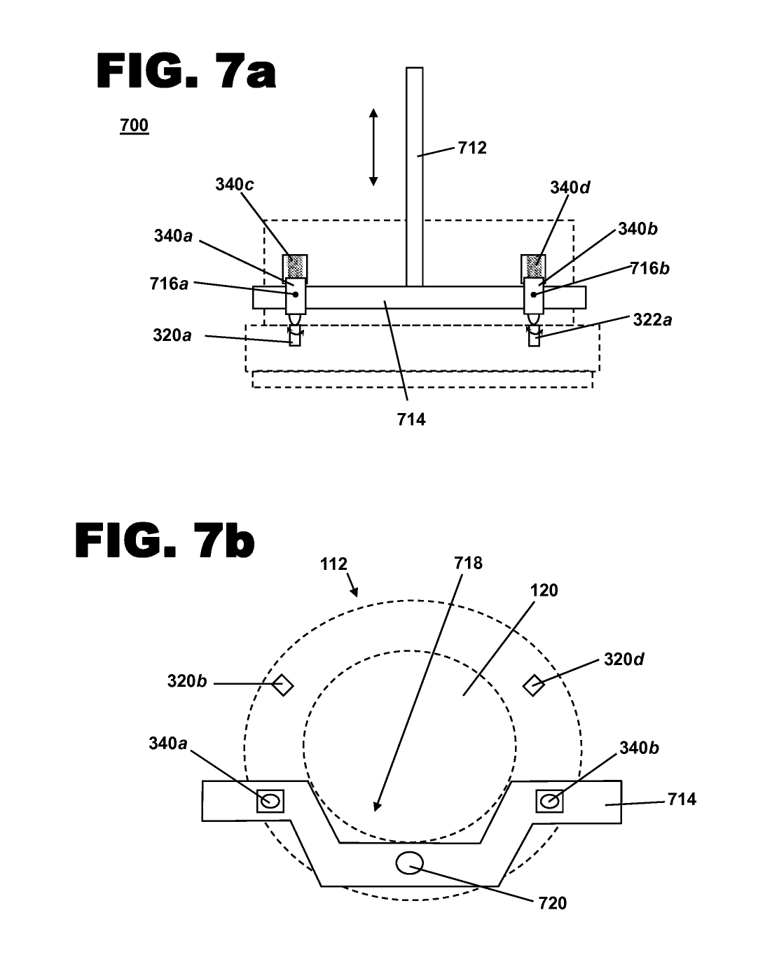

FIG. 7a and FIG. 7b illustrate schematics representative of one example of a force applicator, in accordance with the invention at 700.

Another example of force applicators 310 and 312, is illustrated in FIG. 7a, and includes a stem 712 and a cross-bar 714 in a “T” configuration. Adjacent either end of cross-bar 714 is force transfer units 340a and 340b including spring devices 340c and 340d. In one example, the force transfer units are capable of pivoting about a pivot point 716a and 716b. In one example, the force transfer units are non-pivoting. The force applicator is raised and lowered with stem 712 to engage contact points 320a and 322a. Second force applicator (not shown) engages contact points 320b and 322b shown in FIG. 7b.

FIG. 7b illustrates a top view of the cross-bar 714 of the force applicator. The cross-bar 714 is non-linear including a deviation 718 that allows the cross-bar to circumvent the ink cup 120 of the doctor assembly 112. The stem is fixed to the cross-bar at a connection point 720 located in the approximate center of the cross-bar's length.

In one embodiment, rather than use springs or other mechanical forces, the invention is implemented with pneumatic devices with variable hold down forces.

It is important to note that the figures and description illustrate specific applications and embodiments of the present invention, and is not intended to limit the scope of the present disclosure or claims to that which is presented therein. Upon reading the specification and reviewing the drawings hereof, it will become immediately obvious to those skilled in the art that myriad other embodiments of the present invention are possible, and that such embodiments are contemplated and fall within the scope of the presently claimed invention.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

What is claimed is:

1. A pad printing system, comprising:
a doctor assembly including a first set of opposing contact points and a second set of opposing contact points, wherein the first set is offset from the second set; and
a first force applicator applying force at the first set and a second force applicator applying force at the second set.

2. The system of claim 1, further comprising a cup stop, wherein the cup stop partially limits a lateral motion of the doctor assembly.

3. The system of claim 1 wherein each set of opposing contact points includes at least two contact points.

4. The system of claim 1, wherein the doctor assembly is operably attached to an ink cup having an annular doctor blade.

5. The system of claim 1, wherein at least one of the first force applicator and second force applicator is pivotally attached to the doctor assembly.

6. The system of claim 1, wherein at least one of the first force applicator and second force applicator is fixedly attached to the doctor assembly.

7. The system of claim 1 wherein at least one of the first force applicator and second force applicator is operably connected to a push rod.

8. The system of claim 1, wherein the first force applicator is operably connected to the second force applicator.

9. The system of claim 1, wherein at least one of the first force applicator and second force applicator comprises:
at least one force transfer unit; and
at least one spring device operably connected to the force transfer unit.

10. The system of claim 9, wherein the force transfer unit includes a rod.

11. The system of claim 9, wherein at least one of the first force applicator and second force applicator engages the doctor assembly at one of the contact points through the force transfer unit.

12. The system of claim 9 wherein the spring device provides a modification of the applied force.

13. The system of claim 9 wherein at least one of the first force applicator and second force applicator further comprises a cross-bar, wherein the cross-bar transmits the applied force to the force transfer unit.

14. The system of claim 13, wherein the force transfer unit is pivotally connected to the cross-bar.

15. A method for pad printing, the method comprising:
applying a first force at a first set of contact points;
applying a second force at a second set of contact points, wherein the first set of contact points is offset from the second set of contact points; and
translating one of the doctor assembly or the cliché device relative to each other.

16. The method of claim 15 further comprising:
modifying the first force and the second force whereby the doctor assembly and the cliché device stay in substantially uniform contact as the doctor assembly and the cliché device are translated relative to each other.

17. The method of claim 15 wherein the first force and the second force are modified based on translation of the doctor assembly or the cliché device.

18. A system for pad printing, the system comprising:
means for applying a first force at a first set of contact points;
means for applying a second force at a second set of contact points, wherein the first set is offset from the second set; and
means for translating one of the doctor assembly or the cliché device relative to each other.

19. The system of claim 18, further comprising:
means for modifying the first force and the second force whereby the doctor assembly and the cliché device stay in substantially uniform contact as the doctor assembly and the cliché device are translated relative to each other.
